(19) United States
(12) Patent Application Publication
(10) Pub. No.: US 2025/0352958 A1
(43) Pub. Date: Nov. 20, 2025

(54) Nanofiltration Membrane for Precise Solute-Solute Separation

(71) Applicant: Georgia Tech Research Corporation, Atlanta, GA (US)

(72) Inventors: Yongsheng Chen, Atlanta, GA (US); Yangying Zhao, Atlanta, GA (US)

(21) Appl. No.: 18/036,848

(22) PCT Filed: Nov. 24, 2021
(86) PCT No.: PCT/US21/60793

§ 371 Date: May 12, 2023

Related U.S. Application Data
(60) Provisional application No. 63/117,484, filed on Nov. 24, 2020.

(51) Int. Cl. B01D 71/68; B01D 69/10; B01D 69/12; C02F 1/44

(52) U.S. Cl. CPC B01D 71/68; B01D 69/107; B01D 69/1251; C02F 1/442

(57) ABSTRACT

In a method for making a nanofiltration membrane, an ultrafiltration membrane is disposed onto a support module. A plurality of interface polymerization reactants is applied to the ultrafiltration membrane. The interface polymerization reactants are reacted to form the nanofiltration membrane so that the nanofiltration membrane has a predetermined pore size. A nanofiltration membrane includes an ultrafiltration membrane. An interface polymerized nanofiltration membrane is deposited on the ultrafiltration membrane. The nanofiltration membrane has a predetermined pore size.

### CROSS-REFERENCE TO RELATED APPLICATION(S)

This application claims the benefit of U.S. Provisional Patent Application Ser. No. 63/117,484, filed Nov. 24, 2020, the entirety of which is hereby incorporated herein by reference.

### STATEMENT OF GOVERNMENT SUPPORT

This invention was made with government support under Award No. 2018-68011-28371 awarded by U.S. Department of Agriculture. The government has certain rights in the invention.

### BACKGROUND OF THE INVENTION

### 1. Field of the Invention

The present invention relates to wastewater filtration and, more specifically to membranes that separate nutrients from emerging micropollutants in wastewater.

### 2. Description of the Related Art

Modern agriculture relies on the use of nitrogen (N) and phosphorus (P) fertilizers. The world's demand for N and P₂O₅ for fertilizer use is expected to be 1.1×10¹¹ kg/year and 0.49×10¹¹ kg/year, respectively, by 2022. Currently, the Habor-Bosch process produces most of N fertilizers while consuming about 1% of the world's energy supply. As a non-renewable resource, the phosphate rock that serves as the raw material of P fertilizers is expected to be depleted in 50 to 100 years. In recent years, domestic wastewater (DWW) has gained increasing interests as a precious alternative resource. With proper treatment processes, useful forms of valuable elements including N and P can be separated and recovered from the DWW matrix, providing a reliable source of nutrients while reducing the associated energy demands. Around 30% of N and 15% of P applied in fertilizers ends up in DWW. If effectively recovered, the N and P in DWW streams have the potential to serve more than a half of the global market.

Currently, over 80% of N is converted into nitrogen gas and about 90% of P is lost during precipitation and in landfills in wastewater treatment plants. Meanwhile, most existing technologies of nutrient recovery are targeting side streams that contain no more than 30% of the influent nutrients. As a result, it is highly desirable to develop technologies that enable recovering nutrients from DWW mainstreams with high efficiency.

In one low energy mainline (LEM) process, a majority of organic N and P in the DWW is transferred into plant-friendly inorganic forms (e.g., ammonium and phosphate) through a low-strength anaerobic process. However, the presence of contaminants (e.g., emerging micropollutants (EMPs)) in DWW potentially compromise its applications such as agricultural irrigation. EMPs comprise a large number of prevailing chemical compounds, including pharmaceuticals and personal care products (PPCPs), endocrine disruptors (EDCs), herbicides, surfactants, etc., which undermine the safety of resource recovery from DWW. Several studies have proven that plants may uptake and accumulate EMPs from contaminated irrigation water, resulting in substantial public health concerns. Therefore, selective removal of EMPs while preserving nutrients in DWW is important for DWW resource recovery processes.

Membrane technology could be capable of achieving solute separation without adding excessive chemicals (e.g., acids, bases, oxidants, and coagulants), thereby reducing the uncertainties of the product water. Nano-filter (NF) membranes possess average pore sizes of several angstroms to less than two nanometers, which are appropriate for EMP removal. Size exclusion (steric hindrance), Donnan exclusion (electrostatic exclusion), and dielectric exclusion are the three dominant mechanisms of solute rejection by NF membranes. However, due to the similar properties of EMPs and nutrient ions (e.g., in terms of both molecular size and charge), achieving a high rejection of EMPs and a high permeation of nutrient ions with NF membranes is difficult, requiring precise membrane separation at the Angstrom or even sub-Angstrom scale.

Several commercial NF membranes have been tested to recover P from sewage sludge following acidic hydrolysis or wet oxidation, which converts the sludge into inorganic P-enriched solutions. Although the low pH values (<3.0) of such solutions facilitated the transport of phosphate ions (e.g., H₂PO₄) by reversing the membrane surface charge from negative to positive, the small or inhomogeneous pore sizes of these membranes resulted in undesirably high P rejections (30-50%). A few studies have attempted to fabricate NF membranes that enable lower rejections to phosphorus (<20%) while maintaining high rejections to metal cations (>85%). However, all of these membranes function with highly acidic (pH 0.7-2.0) conditions, which enhance Donnan exclusion to separate cations from P. This requires pH adjustment of both influent and effluent of NF separation, increasing the expense of resource recovery.

Nanofiltration membranes that possess ideally precise solute-solute separation between small nutrient ions (e.g., NH₄⁺, NO₃⁻, and H₂PO₄⁻/HPO₄²⁻) and EMPs under neutral pH preferably should have several fundamental properties. First, the state-of-the-art thin-film composite polyamide (TFC-PA) NF membrane is typically negatively charged due to the formation of carboxyl groups following interfacial polymerization (IP). However, such negative surface charge leads to high rejection of nutrient anions. Thus, the density of membrane surface charge should be lower (e.g., electrically neutral surface charge) to diminish Donnan effects between the membrane surface and solutes and resulting in high rejections of the contaminants with similar sizes but opposite valences. Second, the NF membrane should have precisely controlled pore sizes (e.g., 0.30 to 0.40 nm for certain applications) that are able to differentiate EMPs from smaller nutrient ions. Also, a sharp pore size distribution (i.e., uniform pore size) is an important feature to ensure precise Angstrom or even sub-Angstrom separation.

The generation of such membranes can be achieved by using materials with controllable pores (e.g., graphene oxides). However, forming a continuously defect-free thin-film of those materials is still challenging and the scalability of the corresponding membranes has not yet been achieved. Polymeric TFC-PA membranes, on the other hand, are convenient to fabricate and modify. However, they typically tend to have a wide pore size distribution.

Materials with nanopores or nanochannels, such as metal-organic frameworks (MOFs), MXenes, and nanotubes, can be applied to break the permeability-selectivity trade-off of TFC-PA membranes. Compared to forming a continuous and defect-free nanomaterial layer that is limited by its scalability, fabricating thin-film nanocomposite (TFN) membranes by incorporating nanomaterials into a PA matrix or as an interlayer during the IP process can be more feasible due to their better compatibility with current manufacturing of NF membranes. However, the uncontrolled interactions of the nanomaterials with PA matrix in common practices can result in the majority of nanomaterials embedded in or buried under the active layer of TFN membranes. This can limit the utilization of water-permeable nanopores and nanochannels.

Therefore, there is a need for nano-filtration membranes that selectively separate nutrients from co-existing contaminants at near neutral pH.

### SUMMARY OF THE INVENTION

The disadvantages of the prior art are overcome by the present invention which, in one aspect, is a method for making a nanofiltration membrane, in which an ultrafiltration membrane is disposed onto a support module. A plurality of interface polymerization reactants is applied to the ultrafiltration membrane. The interface polymerization reactants are reacted to form the nanofiltration membrane so that the nanofiltration membrane has a predetermined pore size.

In another aspect, the invention is a nanofiltration membrane that includes an ultrafiltration membrane. An interface polymerized nanofiltration membrane is deposited on the ultrafiltration membrane. The nanofiltration membrane has a predetermined pore size.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIGS. 1A-1C are schematic diagrams illustrating the formation processes and structures of the TIP-MOF, ILIP-MOF, and CAIP-MOF membranes.

FIGS. 2A-2B are chemical diagrams of the cross-linked portion and linear portion of polyamide.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

One embodiment of the invention includes a method of generating TFC-PA NF membranes that precisely tunes certain properties (mean pore size, pore size distribution, and surface charge) through a modified interfacial polymerization (IP) process followed by post-treatment.

One representative embodiment incorporates a polyethylenimine (PEI) monomer and sodium dodecyl sulfate (SDS) surfactant with conventional piperazine (PIP) monomer in the aqueous phase of IP. By varying the concentrations of PEI and SDS, a membrane pore size suitable for separation of nutrient ions from EMPs was achieved and the pore size distribution was sharpened. The post-treatment decreased the density of negative surface charge, further promoting the permeation of P and N anions. The fabricated fit-for-purpose NF membranes exhibited desirable solute-solute selectivity between three representative EMPs (rejection >75%) and inorganic nutrient ions (rejection <25%), outperforming commercial NF membranes. One embodiment incorporated membrane pore size distribution into the Donnan Steric Pore Model with Dielectric exclusion (DSPM-DE). Such a modification pronouncedly improved the prediction accuracy of DSPM-DE for EMP rejection, demonstrating the significance of pore size distribution in manipulating the overall rejection performance.

The following describes a first experimental embodiment:

The following materials were used: Commercial polyethersulfone (PES) ultrafiltration (UF) membrane with molecular weight cutoff (MWCO) of 50 kDa (Synder Filtration, US) was used as the substrate for the fabrication of a PA active layer. Commercial flat-sheet NF membranes (NF270, NF90, HL, XLE, and NFW) were purchased from Sterlitech (US). Piperazine (PIP, ≥99%), 1,3,5-benzenetricarbonyl trichloride (TMC, ≥98%), PEI powder (linear, MW=2.5 kDa), PEI solution (hyperbranched, MW=750 kDa, 5% w/w), SDS (≥99%), n-hexane (≥98.5%), trimethoprim (TMP, ≥99%), diclofenac sodium salt (DCF, ≥99%), carbamazepine (CBZ, ≥99%), glycerol (≥99%), D-(+)-xylose (≥99%), D-(+)-glucose (≥99.5%), poly (ethylene glycol) (pEG, MW=300, 400 and 600 Da), NaOH (≥98%), HCl (1.0 mol/L), as well as all the inorganic salts (NaCl, MgSO₄, NH₄CI, KH₂PO₄, and Ca (NO₃)₂ analytical grade) were supplied by Sigma-Aldrich (MO, US).

Fabrication of TFC-PA NF membranes with controlled properties: The PES UF membrane was soaked in DI water overnight and then hydrolyzed in 1.0 mol/L NaOH solution for 30 min before use. The PA active layer was fabricated on the PES substrate through the IP process. For the fabrication of the control membrane, the PES membrane was fixed on a polytetrafluoroethylene (PTFE) support module with the PES layer facing upward. The membrane was immersed in an aqueous solution of 0.15% (w/v) PIP for 5 min., with the excess solution removed with a rubber roller. The membrane was then immersed in 0.15% (w/v) TMC in n-hexane solution for another 5 min. After pouring off the excess solution, the membrane was cured at 65° C. for 5 min together with the module before being thoroughly washed with DI water. The resultant control membrane fabricated with an aqueous phase containing only PIP was denoted as PIP membrane. In order to fabricate NF membranes with higher selectivity, a certain percentage (from 10% to 90%) of PIP was replaced by linear PEI (LPEI) or hyperbranched PEI (HPEI), with the membranes fabricated by an aqueous phase containing a mixture of PEI and PIP denoted as (L/H)×membrane, where x (from 1 to 9) indicates the weight ratio of PEI in the aqueous phase monomers. The use of both HPEI and LPEI enabled the inventors to investigate the role of PEI molecular structure on membrane properties. Further, surfactant SDS was added in the aqueous phase with PEI and PIP, in order to sharpen the membrane pore size distribution. These membranes are denoted as (L/H)x-Sy membranes, where y represents the concentration of SDS (y mmol/L) in the aqueous phase. To further decrease the negative surface charge of the membranes, some membranes after the IP process were immersed in 0.1% (w/v) LPEI or HPEI solutions for another 5 min before heat curation. These membranes are denoted as (L/H)x-Sy-P membranes. All the fabricated membranes were stored in DI water at 4° C. before validation tests.

The membrane performance was evaluated with a bench-scale cross-flow filtration system. The effective filtration area was 28.3 cm², and the height of the channel was 2 mm. During filtration, permeate and concentrate were recirculated back to the feed tank. Before each set of tests, the membranes were compacted by using DI water at 10 bar for 2 h. All the tests were conducted at the filtration pressure and temperature at 5 bar and 20±1° C., respectively. A cross-flow velocity of 0.35 m/s was maintained through the tests. The rejection tests were carried out using a water matrix containing 1000 μg/L of each EMP and 2 mmol/L of each inorganic salts (NaCl, NH₄Cl, KH₂PO₄, Ca(NO₃)₂, and MgSO₄). The feed water pH was adjusted to 6.0 that is desirable to maintain high availability of nutrients and essential cations for agricultural purpose. At pH 6, most of the phosphorus ions (93.5%) exists as H₂PO₄⁻, with the rest of phosphorus species in the form of HPO₄²⁻. At least 6 hours of stable filtration was performed before sampling.

Theoretical background: DSPM-DE is a widely-used comprehensive model that was originally developed to predict the transport of inorganic ions through NF membranes. This model involves three primary mechanisms that regulate the solute transport, including size exclusion, Donnan exclusion, and dielectric exclusion. Although DSPM-DE has been frequently applied to describe NF rejection to mixed monovalent and multivalent ions, it has limitations due to its major assumptions. One of the key assumptions is that the membrane active layer is modeled to be filled with cylindrical or slit-like pores with uniform pore size, which deviates far from actual scenarios. According to the model, membrane pore size affects convection, diffusion, and electro-migration processes of solute transporting through membrane pores. Incorporating pore size distribution into DSPM-DE, therefore, has the potential to increase the prediction accuracy of this model.

In the DSPM-DE model, four membrane property parameters, including membrane pore radius (rₚ), effective membrane thickness (Δx), membrane volumetric charge density (x), and membrane pore dielectric constant (ϵ_{M}), need to be determined. The inventors took the standard deviation of membrane pore size as an additional parameter to develop a modified DSPM-DE. Specifically, membrane pore size distribution is considered to follow the log-normal probability density function, which is expressed in terms of the mean pore size (rₚ) and standard deviation (sₚ). After rₚ and sₚ were determined, truncation of the log-normal distribution function was performed to negate the effect of the “tail” of large pores. The truncation ensures that only the pores in the NF range were considered in the calculation. In the model, the range of the membrane pore size was set to be 0<r≤2 rₚ. In addition, integration of the log-normal distribution function was performed using the trapezium rule with a step size of 0.05 nm. Since the integral is less than unity, the following distribution function (f′_{R}(r)) was thus defined to scale the distribution by the ratio of areas:

$${f}_{R}^{′} ( r ) = {f}_{R} ( r ) \frac{1}{{\int }_{0}^{{r}_{max}} {f}_{R} ( r ) dr} . \qquad ( 1 )$$

By using this distribution function, the percentage of pores with each specific pore size could be determined, so could the contribution of water permeability by the pores with each specific pore size. After calculating the solute rejection and solute flux of each class of pores, the overall solute rejection of the membrane could also be determined.

The fundamental physicochemical properties, including water permeability, surface charge (indicated by zeta potential at pH 6), average pore size (rₚ), and standard deviation of pore size distribution (Sₚ) of two commercially available NF membranes (NF270 and NF90 membranes) and representative membranes prepared as part of the experimental embodiment are shown in Table 1. NF270 and NF90 membranes represent semi-aromatic (PIP based) and fully aromatic (m-phenylenediamine based) polyamide membranes, respectively. Preliminary screening of membrane performance showed that L3-S2-P and H2-S4-P membranes possessed the best solute-solute selectivity among membranes fabricated with linear and hyperbranched PEI, respectively (data not shown). Therefore, these two membranes and other membranes fabricated with the same PEI and/or SDS contents were characterized in order to elucidate the effects of PEI structure (L or H) and concentration (Lx or Hx), SDS concentration (—Sy), and PEI post-treatment (—P) on membrane properties.

TABLE 1
Fundamental physicochemical properties of selected commercial and
membranes fabricated according to the experimental embodiment:

| | Water | Zeta | | |
|---|---|---|---|---|
| | permeability | potential | | |
| Membrane | (L/m2 · h · bar) | (mV, pH 6) | rₚ (nm) | Sₚ |
| NF270 | 23.3 ± 0.4 | −20.4 ± 2.0 | 0.365 | 0.267 |
| NF90 | 7.6 ± 0.3 | −17.9 ± 2.2 | 0.279 | 0.225 |
| PIP | 8.1 ± 0.5 | −12.8 ± 1.2 | 0.381 | 0.291 |
| PIP-S2 | 8.4 ± 1.1 | −10.1 ± 0.7 | 0.342 | 0.166 |
| L3 | 12.3 ± 0.6 | −5.2 ± 1.7 | 0.404 | 0.301 |
| L3-P | 12.7 ± 0.7 | 7.9 ± 1.9 | 0.399 | 0.298 |
| L3-S2 | 14.4 ± 0.9 | −3.7 ± 1.1 | 0.365 | 0.162 |
| L3-S2-P | 14.2 ± 0.5 | 2.6 ± 1.7 | 0.363 | 0.178 |
| H2 | 8.0 ± 0.3 | −4.7 ± 0.3 | 0.398 | 0.325 |
| H2-P | 11.3 ± 0.4 | 6.3 ± 1.9 | 0.446 | 0.296 |
| H2-S4 | 12.8 ± 0.6 | −4.3 ± 1.3 | 0.351 | 0.252 |
| H2-S4-P | 13.1 ± 0.3 | −1.9 ± 1.2 | 0.356 | 0.259 |

The pure water permeabilities of the fabricated membrane were lower than that of commercial NF270, possibly due to the higher thicknesses of PA active layer. The dissociation of carboxyl groups, which are formed from hydrolysis of unreacted acyl chloride in the IP process, endows TFC-PA membranes with negative surface charge at near neutral pH. With the same monomers used in IP, PIP membrane had a lower surface charge density (i.e., lower absolute value of zeta potential), due to its higher crosslinking degree (0.71 and 0.60 for PIP and NF270 membranes, respectively). The incorporation of PEI decreased or even reversed the negative charge of membrane surface, due to the protonation of amine groups at near neutral pH. The zeta potentials of LPEI and HPEI solutions (1 mg/mL) were 20.9+4.4 mV and 7.4+3.7 mV, respectively. Thus, LPEI possesses a higher density of positive charge than HPEI, partially contributing to the more positively charged surface of L3-S2-P membrane than H2-S4-P membrane. Furthermore, the introduction of SDS facilitates the transfer of aqueous-phase monomers to the water-organic interface and therefore increases the crosslinking degree. The resultant lower density of carboxylic groups on the membrane surface reacted with fewer PEI molecules during the post-treatment, leading to lower positive surface charges of L3-S2-P and H2-L4-P membranes than those of L3-P and H2-P membranes.

The rejection of small, neutral organic molecules (e.g., sugars and PEGs) is dominated by size exclusion, which is directly governed by membrane pore sizes. Therefore, the average pore size (rₚ) and standard deviation (Sₚ) of pore size distribution can be estimated according to the rejections of a series of sugars and PEGs. The PIP membrane fabricated in this study shared the same type of water-phase monomer with NF270 membrane. With a lower concentration of PIP than commonly used IP recipes, the rₚ (0.381 nm) and Sₚ (0.291) of PIP membrane are both slightly higher than those of NF270 membrane. The addition of PEI, in the aqueous phase (regardless of the molecular structure) increased the membrane pore sizes, but post-treatment using PEI did not impose any remarkable effect on membrane pore size. One notable result was the influence of SDS addition on pore size distribution. The addition of 2 mM SDS in the mixture of LPEI and PIP (LPEI: PIP-3:7 w/w) dramatically decreased Sp from 0.298 to 0.158, indicating the effectiveness of SDS surfactant in sharpening pore size distribution of TFC-PA membrane.

Considering all the physicochemical properties (surface charge, average pore size, and pore size distribution) of the prepared membranes, proper additions of PEI and SDS as well as post-treatment contributed to the formation of a nearly neutrally charged NF membrane with sharp pore size distribution (i.e., L3-S2-P membrane), which has the potential to achieve high solute-solute selectivity to separate EMPs and inorganic nutrient ions efficiently in our study.

In another experimental embodiment, a capillary-assisted interfacial polymerization (CAIP) process was to fabricate metal organic framework (MOF)-incorporated TFN membranes (referred to as CAIP-MOF membranes hereafter). These membranes excel in both solute-solute selectivity and water permeability. Distinct from current fabrications of TFC-PA and TFN membranes, the water-phase amine monomer in the CAIP is uniquely driven by nanocapillary force along gaps between MOF nanoparticles (NPs) before participating in polymerization at the water-organic interface, which regulates the MOF-PA interaction in a more controllable and precise manner. This approach exposes more MOF nanochannels on the membrane surface and creates a gradient of PA cross-linking degree, both of which contribute to overcoming the upper-bound of perm-selectivity in TFC-PA membranes. It was found that the CAIP-MOF membrane outperformed conventional TFC-PA membranes and TEN membranes in the separation of both long-chain and short-chain PFAS from nutrient ions (e.g., phosphates) in the synthetic effluent of an anaerobic membrane bioreactor (AnMBR), while displaying good resistance to organic fouling. By performing detailed membrane characterizations, the experimental embodiment was supported by unequivocal evidence of the important role of nanocapillary in improving both solute-solute selectivity and water permeability of TFN membranes. Also, molecular dynamic (MD) simulations revealed the mechanisms underlying the formation of polyamide with a cross-linking gradient within the CAIP-MOF membranes.

The materials used to fabricate this experimental embodiment were as follows: Zirconyl chloride octahydrate (ZrOCl₂·8H₂O, ≥98%), 4-imidazolecarboxaldehyde (≥98%), N,N-dimethylformamide (DMF, ≥99.8%), p-toluenesulfonic acid (≥98.5%), 2-aminoterephthalic acid (≥99%), acetic acid (≥99.7%), acetone (≥99.5%), methanol (≥98%), polyethersulfone (PES), piperazine (PIP, ≥99%), 1,3,5-benzenetricarbonyl trichloride (TMC, ≥98%), n-hexane (≥98%), diiodomethane (≥99%), ethylene glycol (≥99.8%), glycerol (≥99%), D-(+)-xylose (≥99%), D-(+)-glucose (≥99.5%), poly (ethylene glycol) (PEG, MW=300, 400 and 600 Da), ammonium acetate (≥98%), acetonitrile (≥99.8%), NaOH (≥98%), HCl (1.0 mol/L), as well as a set of per-and polyfluoroalkyl substances (PFAS) were purchased from Sigma-Aldrich (St. Louis, MO, USA). Sodium alginate, humic acid (>98%), and inorganic salts (NaCl, MgSO₄·7H₂O, NH₄Cl, KH₂PO₄, KHCO₃, and CaCl₂·2H₂O, analytical grade) were supplied by Fisher Scientific (Pittsburgh, PA, USA).

Commercial NF membranes (NF270, NF90, HL, XLE, NFW, and NFX) were purchased from Sterlitech Corp. (Kent, WA, USA). Polyvinyl alcohol (PVA) sponges were purchased from MeMaster-Carr (Elmhurst, IL, USA).

The MOF NPs were synthesized and then functionalized with imidazole rings. The functionalized NPs, referred to as UiO-66-NCIM, were synthesized by linking imidazoles with UiO-66-NH2 via —N═C-bonds. For the synthesis of UiO-66-NH₂ nanoparticles (NPs), 0.21 g ZrOCl₂·8H₂O and 0.55 g 2-aminoterephthalic acid were dissolved in 40 mL DMF. The mixture was stirred for 10 min prior to the addition of 3.7 g acetic acid. After ultrasonication for 10 min, the solution was transferred to an autoclave and treated at 90° C. for 18 h. The products were collected by centrifugation at 8000 rpm for 10 min. The supernatants were discarded and the UiO-66-NH₂ NPs (i.e., the solid residues) were extensively washed with acetone for three times, with methanol for three times, and then dried under vacuum at 75° C. overnight. UiO-66-NCIM NPs were synthesized by dispersing the UiO-66-NH2 in 40 mL ethanol together with 0.5 g 4-imidazolecarboxaldehyde and 0.01 g p-toluenesulfonic acid, followed by being stirred and refluxed at 80° C. for 12 h. The resultant UiO-66-NCIM NPs were collected by centrifugation at 8000 rpm for 10 min and washed with acetone and methanol in sequence (repeated for three times each). Both UiO-66-NH2 and UiO-66-NCIM NPs were stored in methanol at 4° C. before use.

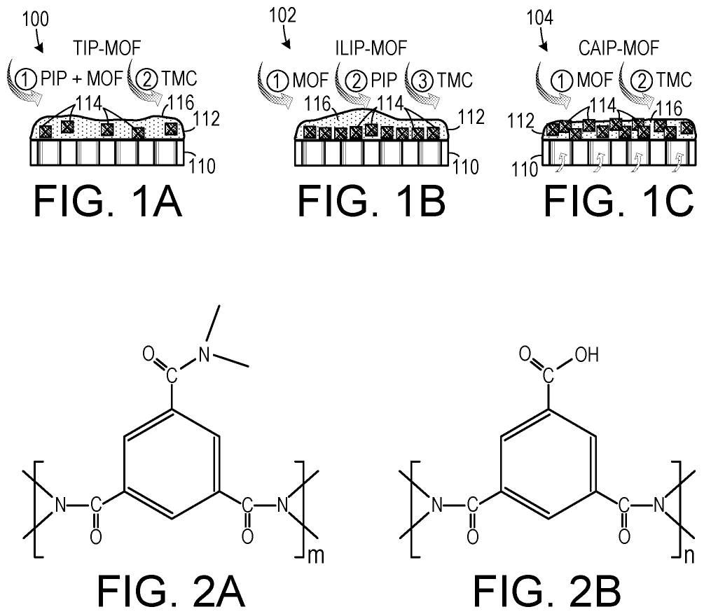

For comparing with the CAIP-MOF membrane, three conventional TFC or TFN membranes were created by traditional IP (referred to as the TIP membrane), mixing the UiO-66-NCIM NPs with piperazine (referred to as the TIP-MOF membrane), or using the MOFs as an interlayer (referred to as the ILIP-MOF membrane), as shown in FIGS. 1A-1C. In these figures, a PES support membrane 110 supports an active (NF) layer 112, which includes a MOF 114 supporting the polymerization results 116. FIG. 1A shows formation of a TIP-MOF membrane 100, FIG. 1B shows formation of an ILIP-MOF membrane 102 and FIG. 1C shows formation of a CAIP-MOF membrane 104.

The TIP membranes were fabricated by forming a PA layer on a polyethersulfone ultrafiltration (PES UF) support membrane via the IP reaction of piperazine (PIP) (0.15% w/v in water) with 1,3,5-benzenetricarbonyl trichloride (TMC) (0.15% w/v in n-hexane). The TIP-MOF membranes 100 were fabricated by blending MOF NPs with the aqueous PIP solutions during the IP process. The ILIP-MOF membranes 102 were prepared by depositing MOF NPs on the PES support membrane, followed by the IP reaction (i.e., the MOF NPs perform as an interlayer between the PA active layer and PES support membrane). The CAIP-MOF membranes 104 were fabricated by depositing MOF NPs on the PES support membrane. Then the membranes were transferred onto a pre-soaked PVA sponge with different saturation levels of PIP solutions. After contacting for 1 min, the membranes were carefully removed from the sponge, air-dried for 5 min, and impregnated in the TMC solution for another 1 min. For the fabrication of TIP-MOF, ILIP-MOF, and CAIP-MOF membranes, the other fabrication steps (including reagent concentrations) were identical to those fabrication steps of the TIP membranes.

The PES support membranes 110 were synthesized as follows: the membrane casting solution was first prepared by dissolving 15% (w/v) PES in DMF and vigorously stirred for 12 h. The solution was then poured onto a clean glass plate and cast by a casting knife. After casting, the glass plate carrying the casting film was immediately immersed in deionized (DI) water and left overnight for complete phase inversion. Finally, the PES membrane was rinsed thoroughly and stored in DI water at 4° C. before use. The properties of the PES membranes are shown in the following table:

TABLE 2
Properties of the PES membranes.

| | Average | Water | Contact | | | |
|---|---|---|---|---|---|---|
| MWCO | pore | permeability | angle | Elemental composition (%) | | |
| (Da) | size (nm) | (LMH/bar) | (°) | C | O | S |
| 50,000 | ~6.0 | ~65 | 49.8 ± | 77.1 | 18.0 | 4.9 |
| | | | 2.5 | | | |

The PES membrane was soaked in DI water overnight and then hydrolyzed in 1.0 mol/L NaOH solution for 30 min before use. For fabricating a thin-film composite polyamide (TFC-PA) membrane via traditional interfacial polymerization (i.e., the TIP membrane), the PES membrane was fixed on a polytetrafluoroethylene (PTFE) support module and immersed in an aqueous solution of 0.15% w/v PIP for 2 min with the excess solution removed with an air knife. The membrane was then immersed in 0.15% w/v TMC in n-hexane solution for 1 min, which resulted in a PA layer due to the interfacial polymerization (IP) process. After pouring off the excess solution, the membrane was cured at 65° C. for 5 min before being thoroughly washed with DI water.

In this experimental embodiment two conventional thin-film composite (TFN) membranes were fabricated by mixing the metal organic frameworks (MOFs, UiO-66-NCIM nanoparticles (NPs), for example) with PIP (i.e., the TIP-MOF membrane 100) or using as MOFs an interlayer (i.e., the ILIP-MOF membrane 102). The TIP-MOF membranes 100 were fabricated by simply mixing a certain amount of UIO-66-NCIM NPs together with PIP in the aqueous-phase solution. The solutions containing MOFs were pretreated by ultrasonication for 10 min before the IP process. These membranes are denoted as TIP-x membranes, where x (% w/v) indicates the MOF loadings.

The ILIP-MOF membranes 102 were prepared via two steps. First, the UiO-66-NCIM NPs are dispersed in water at a concentration of 10 μg/mL. The solution was ultrasonicated for 10 min before being filtered through the PES membrane, forming an interlayer of y μg MOF/cm² loading. After being air-dried for 5 min, a PA layer was then fabricated upon the MOF-loaded membrane surface through the same IP procedure as described above. These membranes are denoted as ILIP-y.

The CAIP-MOF membranes 104 were also prepared by firstly depositing y μg MOF/cm² of NPs on the PES membrane. The MOF-loaded membrane was then air-dried for 5 min and was transferred on a PVA sponge. The sponge was pre-soaked with 0.15% w/v PIP solution, resulting in a saturation level of z (z is in the range of 0 to 1, with values of 0 and 1 representing no pre-soaking to fully saturated soaking). An experimental measurement showed that the required volume of PIP solution to fully saturate the soaked PVA sponge was 0.986 mL/cm³ (˜5.6 g/g). After standing for 1 min, the membrane was carefully removed and air-dried for another 5 min before being impregnated with 0.15% w/v TMC solution. The following procedures were the same as those described above. These membranes are denoted as CAIP-y-z.

All the membranes were stored in DI water at 4° C. overnight before use.

The molecular radius of small neutral organic molecules, i.e., glycerol (92 Da), xylose (150 Da) and glucose (180 Da), can be calculated by Eq. S1:

$$log {r}_{i} = - 1.4962 + 0.4 \; 654 log ( M W ) \qquad ( S1 )$$

The molecular radius of PEGs (MW of 300, 400 and 600 Da) can be calculated by Eq. S2:

$${r}_{i} = 16.73 \times {( M W )}^{0.557} \times 1 {0}^{- 3} \qquad ( S2 )$$

where the rᵢ (nm) is the molecular radius.

The average pore radius and pore size distribution of a membrane was calculated using a log-normal model:

$$σ ( {r}^{*} ) = {\int }_{0}^{r} \frac{1}{{S}_{p} \sqrt{2 π}} \frac{1}{r} exp ( - \frac{( lnr - {lnr}_{p} )}{2 {S}_{p}} ) dr \qquad ( S3 )$$

where σ(r*) is the reflection coefficient, rₚ is the average pore radius, which determines the center of the pore size distribution curves, and Sₚ is the standard deviation of the (logarithm of the) pore size distribution, which determines the sharpness of the pore size distribution curve.

Calculation of the cross-linking degree of polyamide structure: The cross-linking degree of polyamide structure was calculated using elemental ratios of oxygen/nitrogen (O/N). The polyamide structure is composed of two portions: a cross-linked portion (m) where all three acyl chlorides in the TMC molecule are reacted with the amine groups of the aqueous phase monomers (PIP or PEI), and a linear portion (n) where only two of the three acyl chlorides are reacted with the amine groups, as shown in FIGS. 2A and 2B. The O:N ratio is 3:3 and 4:2 in the cross-linked portion (m) and the linear portion (n), respectively. Thus, the cross-linking degree (D) was calculated via:

$$\frac{O}{N} = \frac{4 n + 3 m}{2 n + 3 m} \qquad ( S4 )$$

$$D = \frac{m}{m + n} \times 100 \% \qquad ( S5 )$$

where the O:N ratio was determined by XPS measurement. The O and N atomic percentages of the polyamide for TFN membranes are calculated by the XPS results subtracting the elements from the MOF NPs.

Overall, CAIP generates a MOF-PA nanocomposite active layer with distinct structures from those of current TFN membranes. The nanocapillary rise of the aqueous solution confines the formation of the PA matrix within the gaps of pre-deposited MOF NPs, ensuring an exceptionally high exposure of water-permeable and solute-selective nanochannels of the MOF NPs on the membrane surface (i.e., facing the feedwater). Meanwhile, the heterogeneous distribution of the water-phase monomers during the capillary rise creates a PA matrix with a cross-linking gradient in the vertical direction that further enhances water transport. As a result, the CAIP-MOF membrane exhibits considerably improved water permeability and solute-solute selectivity between nutrients and PFAS, breaking the perm-selectivity trade-off of TFC-PA NF membranes. This CAIP approach provides a new avenue of combining highly designable structures of NPs with highly flexible PA in fabricating the next-generation, fit-for-purpose TFN membranes for precise solute-solute separation.

The invention includes a method to fabricate a nanofiltration (NF) membrane through interfacial polymerization (IP) and post-treatment processes using different water-phase (e.g., piperazine and polyethylenimine) and organic-phase (e.g., trimesoyl chloride and m-phenylenediamine) monomers and surfactants (e.g., sodium dodecyl sulfate). The properties, such as pore size (distribution) and charge. of the NF membrane are fine-tuned by adjusting the types and concentrations of monomers/surfactants, and fabrication/post-treatment conditions. The NF membrane with precise solute-solute selectivity can be used for water/wastewater treatment and resource recovery. Representative potential applications of the invention include: 1) selective recovery of nutrient ions (e.g., N, P, K) while removing emerging contaminants from wastewater streams; 2) selective separation of valuable elements (e.g., lithium and rare earth elements) from other inorganic ions (e.g., magnesium and calcium) or organic compounds; 3) pre-treatment of reverse osmosis membranes by removing divalent ions (e.g., Mg2+, Ca2+, and SO42−) while maintaining monovalent ions (e.g., Na+ and Cl−), thereby reducing membrane fouling potential.

In bench-scale experiments, the inventors further evaluated the selectivity factor (SP,EMP) between nutrient phosphates and emerging micro-pollutants (trimethoprim, diclofenac, and carbamazepine) of our solute-solute selective NF (L3-S2-P) and five commercial NF membranes. The SP,EMP value of the L3-S2-LP membrane was as high as 5.20, and the SP, EMP values of the commercial membranes NF270, NF90, HL, XLE, and NEW were 1.37, 0.71, 0.51, 0.87, and 0.89, respectively. In addition, the selectivity factor (SP, PFAS) between nutrient phosphates and 7 kinds of prevailing PFAS (PFBA, PFBS, PFHpA, PFHxS, PFOA, PFNA, and PFOS) of these membranes was tested. The membrane (with a SP, PFAS value of 2.46) outperformed the commercial membranes NF270, NF90, HL, XLE, NFW, and NFX (with SP, PFAS values of 0.42-1.85) as well.

Compared to other phosphorus recovery processes (e.g., struvite precipitation), the solute-solute selective NF is able to recover P from the mainstream of wastewater, induces no additional chemicals, and does not require a comparably high P concentration in the feed water.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112 (f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for making a nanofiltration membrane, comprising the steps of:
(a) disposing an ultrafiltration membrane onto a support module;
(b) applying a plurality of interface polymerization reactants to the ultrafiltration membrane; and
(c) reacting the interface polymerization reactants to form the nanofiltration membrane so that the nanofiltration membrane has a predetermined pore size.

2. The method of claim 1, wherein the support module comprises polytetrafluoroethylene (PTFE).

3. The method of claim 1, wherein the ultrafiltration membrane comprises a polyethersulfone (PES) membrane.

4. The method of claim 1, wherein step of applying a plurality of interface polymerization reactants comprises the step of incorporating a polyethylenimine (PEI) monomer and a sodium dodecyl sulfate (SDS) surfactant with piperazine (PIP) monomer in an aqueous phase of the interface polymerization.

5. The method of claim 4, further comprising the step of tuning the pore size to achieve the predetermined pore size by varying concentrations of PEI and SDS during the reacting step.

6. The method of claim 5, wherein the PEI includes at least one of liner PEI (LPEI) or hyperbranched PEI (HPEI).

7. The method of claim 5, wherein the interface polymerization reactants include between PEI in a range of between 10% to 90% and PIP in a range of between 10% to 90%.

8. The method of claim 1, wherein step of applying a plurality of interface polymerization reactants comprises the steps of:
(a) dispersing an metal organic framework (MOF) in water;
(b) adding a piperazine (PIP) monomer in an aqueous-phase solution to the MOF; and
(c) reacting the MOF and PIP with 1,3,5-benzenetricarbonyl trichloride (TMC) so as to form a polyamide nanofiltration membrane layer.

9. The method of claim 8, wherein the MOF comprises UiO-66-NCIM.

10. The method of claim 8, further comprising the step of ultrasonicating the MOF prior to the step of adding PIP.

11. The method of claim 1, wherein step of applying a plurality of interface polymerization reactants comprises the steps of:
(a) dispersing an metal organic framework (MOF) in water;
(b) ultrasonicating the MOF and water for a predetermined amount of time;
(c) filtering the MOF and water through the ultrafiltration membrane after the ultrasonicating step so as to form an interlayer; and
(d) reacting the interlayer with 1,3,5-benzenetricarbonyl trichloride (TMC) so as to form a polyamide nanofiltration membrane layer.

12. The method of claim 1, wherein step of applying a plurality of interface polymerization reactants comprises the steps of:
(a) depositing metal organic framework (MOF) nanoparticles on the ultrafiltration membrane;
(b) placing the ultrafiltration membrane with the MOF nanoparticles onto source of piperazine (PIP) monomer solution;
(c) allowing the PIP monomer solution to pass through the ultrafiltration membrane by capillary action to form a preliminary membrane;
(d) drying the preliminary membrane for a predetermined amount of time; and
(e) impregnating the preliminary membrane with a 1,3,5-benzenetricarbonyl trichloride (TMC) solution so as to form a polyamide nanofiltration membrane layer.

13. The method of claim 12, wherein the source of PIP monomer solution comprises a sponge soaked in PIP.

14. The method of claim 12, wherein the predetermined amount of time for the drying step comprises five minutes.

15. A nanofiltration membrane, comprising:
(a) an ultrafiltration membrane; and
(b) an interface polymerized nanofiltration membrane deposited on the ultrafiltration membrane, the nanofiltration membrane having a predetermined pore size.

16. The nanofiltration membrane of claim 15, wherein the predetermined pore size is in range of from 0.3 nm to 0.4 nm.

17. The nanofiltration membrane of claim 15, further comprising a support module upon which is disposed the ultrafiltration membrane.

18. The nanofiltration membrane of claim 17, wherein the support module comprises polytetrafluoroethylene (PTFE).

19. The nanofiltration membrane of claim 15, wherein the ultrafiltration membrane comprises a polyethersulfone (PES) membrane.

20. The nanofiltration membrane of claim 15, wherein the interface polymerized nanofiltration membrane comprises a polyethylenimine (PEI) that has polymerized with a piperazine (PIP) monomer.

15. anofiltration membrane of claim 15, wherein the interface polymerized nanofiltration membrane comprises:
(a) a metal organic framework (MOF); and
(b) piperazine (PIP) reacted the MOF.

21. anofiltration membrane of claim 21, wherein the MOF comprises UiO-66-NCIM.
